(19) United States
(12) Patent Application Publication
(10) Pub. No.: US 2001/0037272 A1
(43) Pub. Date: Nov. 1, 2001

(54) Information display apparatus

(76) Inventors: Hisanori Kobayashi, Tokyo (JP); Kiyoshi Kanai, Tokyo (JP); Mina Horiuchi, Tokyo (JP)

Correspondence Address: Pillsbury Madison & Sutro LLP, Intellectual Property Group, Ninth Floor, East Tower, 1100 New York Avenue, N.W., Washington, DC, 20005-3918, US

(21) Appl. No.: 09/795,708

(22) Filed: Mar. 1, 2001

(30) Foreign Application Priority Data
Mar. 1, 2000 (JP) 2000-55496

(51) Int. Cl. G06F 17/60

(52) U.S. Cl. 705/35

(57) ABSTRACT

An information display apparatus including: a receiver connecting to a network and receiving financial information through the network; a reservoir connecting to an output side of the receiver and accumulating the financial information received from the receiver; a specifying-information-accepting unit for accepting specifying information that specifies the financial information accumulated in the reservoir to be a basis of predetermined information to be displayed; an information selector connecting to the specifying-information-accepting unit and the reservoir and selecting financial information specified by the predetermined information accepted by the specifying-information-accepting unit from the financial information accumulated in the reservoir; and a display processing unit connecting to an output of the information selector and displaying the predetermined information based on the financial information selected by the information selector.

This patent application claims priority from a Japanese patent application No. 2000-55496 filed on Mar. 1, 2000, the contents of which are incorporated herein by reference.

### BACKGROUND OF THE INVENTION

1. Field of the Invention

The present invention relates to an information display apparatus, which receives financial information through a network and displays predetermined information based on the received financial information. For example, the present invention relates to an information display apparatus that receives, as financial information, price information on a plurality of fluctuating objects in a financial market.

2. Description of the Related Art

Conventionally, it is known that there is an information display system, in which a host computer transmits financial information, including information about prices (price information) of objects having fluctuating values (fluctuating objects), such as base prices of investment trusts, price of stocks, and index prices of various stock price indexes, to an information display apparatus through a network, and displays predetermined information based on the financial information received by the information display apparatus. For example, there has been known a stock price index, such as TOPIX, or Tokyo Stock Exchange Stock Price Index, is calculated based on an aggregate market value of all listed stocks of the First Section of the Tokyo Stock Exchange, and Nikkei 225, a Nikkei Stock Average, is calculated based on stock prices of designated 225 stocks.

The information display apparatus displays, for example, price bases of all investment trusts that are sent through the network. The information display apparatus also displays, for example, graphs showing the fluctuation of price bases of investment trusts.

It is requested that an information display apparatus appropriately provides to users information relating to financial information. It is also requested that the information display apparatus provides various information based on the past financial information that may be useful for future markets.

### SUMMARY OF THE INVENTION

Therefore, it is an object of the present invention to provide an information display apparatus, which is capable of appropriately providing to users information relating to financial information. The above and other objects can be achieved by combinations described in the independent claims. The dependent claims define further advantageous and exemplary combinations of the present invention.

According to a first aspect of the present invention, an information display apparatus includes: a receiver connecting to a network and receiving financial information through the network; a reservoir connecting to an output side of the receiver and accumulating the financial information received from the receiver; a specifying-information-accepting unit for accepting specifying information that specifies the financial information accumulated in the reservoir to be a basis of predetermined information to be displayed; an information selector connecting to the specifying-information-accepting unit and the reservoir and selecting financial information specified by the predetermined information accepted by the specifying-information-accepting unit from the financial information accumulated in the reservoir; and a display processing unit connecting to an output of the information selector and displaying the predetermined information based on the financial information selected by the information selector.

According to the invention, a display pattern of the predetermined information is modified by the display processing unit based on the financial information selected by the information selector with a display pattern of information based on other financial information.

In an aspect to the invention, the receiver sequentially receives information about a value of a plurality of fluctuating objects in a financial market through the network; the reservoir accumulates the information about a value of the fluctuating objects received by the receiver; and the display processing unit generates a graph relating to each fluctuation of the plurality of fluctuating objects based on the information about a value accumulated in the reservoir and simultaneously displays the generated graph.

The information display apparatus according to the invention may further include a combined value processing unit connecting between the selector and the display processing unit and calculating combined value information of a plurality of time points, the combined value information is made by a predetermined calculation about the information about a value of the same time point of a plurality of the fluctuating objects based on the information about a value accumulated in the reservoir, wherein the display processing apparatus displays a graph showing a relationship between the combined value information and the time point based on the combined value information of a plurality of time points calculated by the combined value processing unit.

The above objects can also be achieved by a provision of a method of displaying information which includes: receiving financial information through a network; accumulating the financial information received by the receiver; accepting specifying information that specifies the financial information accumulated in the reservoir to be a basis of predetermined information to be displayed; selecting financial information specified by the predetermined information accepted by the specifying-information-accepting unit from the financial information accumulated in the reservoir; and displaying the predetermined information based on the financial information selected by the information selector.

According to an aspect of the invention, a display pattern of the predetermined information is modified based on the financial information selected by the information selector with a display pattern of information based on other financial information.

In an aspect of the invention, the receiving sequentially receives information about a value of a plurality of fluctuating objects in a financial market through the network; the accumulating accumulates the information about a value of the fluctuating objects received by the receiver; and the displaying generates a graph relating to each fluctuation of the plurality of fluctuating objects based on the information about a value accumulated in the reservoir and simultaneously displays the generated graph.

The information display method according to the invention may further include calculating combined value information of a plurality of time points, the combined value information is made by a predetermined calculation about the information about a value of the same time point of a plurality of the fluctuating objects based on the information about a value accumulated in the reservoir, wherein the displaying displays a graph showing a relationship between the combined value information and the time point based on the combined value information of a plurality of time points calculated by the combined value processing unit.

The above objects can also be achieved by a provision of a program for displaying information which includes: a receiving module for receiving financial information through a network; an accumulating module for accumulating the financial information received by the receiver; an accepting module for accepting specifying information that specifies the financial information accumulated in the reservoir to be a basis of predetermined information to be displayed; a selecting module for selecting financial information specified by the predetermined information accepted by the specifying-information-accepting unit from the financial information accumulated in the reservoir; and a displaying module for displaying the predetermined information based on the financial information selected by the information selector.

According to the invention, a display pattern of the predetermined information is modified based on the financial information selected by the information selector with a display pattern of information based on other financial information.

In an aspect of the invention, the receiving module sequentially receives information about a value of a plurality of fluctuating objects in a financial market through the network; the accumulating module accumulates the information about a value of the fluctuating objects received by the receiver; and the displaying module generates a graph relating to each fluctuation of the plurality of fluctuating objects based on the information about a value accumulated in the reservoir and simultaneously displays the generated graph.

The program according to the invention may further includes a calculating module for calculating combined value information of a plurality of time points, the combined value information is made by a predetermined calculation about the information about a value of the same time point of a plurality of the fluctuating objects based on the information about a value accumulated in the reservoir, wherein the displaying module displays a graph showing a relationship between the combined value information and the time point based on the combined value information of a plurality of time points calculated by the combined value processing unit.

The objects of the invention can still be achieved by a provision of an information display system which includes: a host computer generating financial information; a network connecting to the host computer and transmitting the financial information; a receiver connecting to the network and receiving the financial information; a reservoir connecting to an output of the receiver and accumulating the financial information received by the receiver; a specifying-information-accepting unit for accepting specifying information that specifies the financial information accumulated in the reservoir to be a basis of predetermined information to be displayed; and an information selector connecting to the specifying-information-accepting unit and the reservoir and selecting financial information specified by the predetermined information accepted by the specifying-information-accepting unit from the financial information accumulated in the reservoir.

The above objects can also be achieved by a provision of an information displaying system which includes: a receiver connecting to a network and sequentially receiving information about a value of a plurality of fluctuating objects in a financial market through the network; a reservoir connecting to an output of the receiver and accumulating the information about a value of the fluctuating objects received by the receiver; a combined value processing unit connecting to the reservoir and calculating combined value information of a plurality of time points, the combined value information is made by a predetermined calculation about information about a value of the same time point of a plurality of fluctuating objects based on the information about a value accumulated in the reservoir; and a display processing unit connecting to the combined value processing unit and generating a graph relating to each fluctuation of the plurality of fluctuating objects based on the information about a value accumulated in the reservoir, simultaneously displaying the generated graph, and displaying a graph showing a relationship between the combined value information and the time point based on the combined value information of a plurality of time points calculated by the combined value processing unit.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a structural diagram showing an information display system, which includes an information display apparatus according to a first embodiment of the present invention.

FIG. 2 illustrates data structures to be sent to the information display apparatus from a host computer according to the first embodiment of the present invention.

FIGS. 3A, B, and C are structural diagrams showing data accumulated in a reservoir according to the first embodiment of the present invention.

FIG. 4 is an exemplary graph display of a table including information relating to investment trust issues according to the first embodiment of the present invention.

FIGS. 5A,B, and C are exemplary graph displays relating to financial information according to the first embodiment of the present invention.

FIG. 6 is a structural diagram of an information display apparatus according to a second embodiment of the present invention.

FIG. 7 is a structural diagram showing data accumulated in a reservoir according to the second embodiment of the present invention.

FIG. 8 is an exemplary diagram of a table relating to financial information according to the second embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

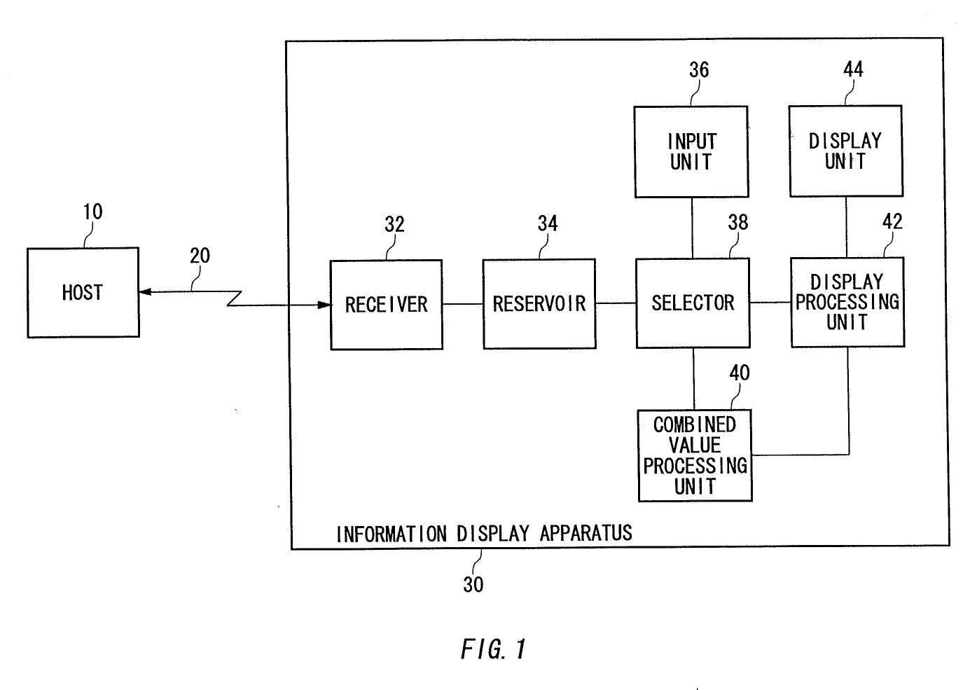

FIG. 1 is a structural diagram showing an information display system, which includes an information display apparatus according to a first embodiment of the present invention. The information display system includes a host computer 10, an information display apparatus 30, and a network 20 for connecting the host computer 10 with the information display apparatus 30. The host computer 10 sends financial information to the information display apparatus 30 through the network 20, such as information on price bases relating to investment trusts, information on stock prices, and information on index prices of stock price averages. The host computer 10 is located, for example, at the Tokyo Stock Exchange and provides the latest financial information in real time. On the other hand, the information display apparatus 30 is located, for example, at investment trusts brokers such as securities companies.

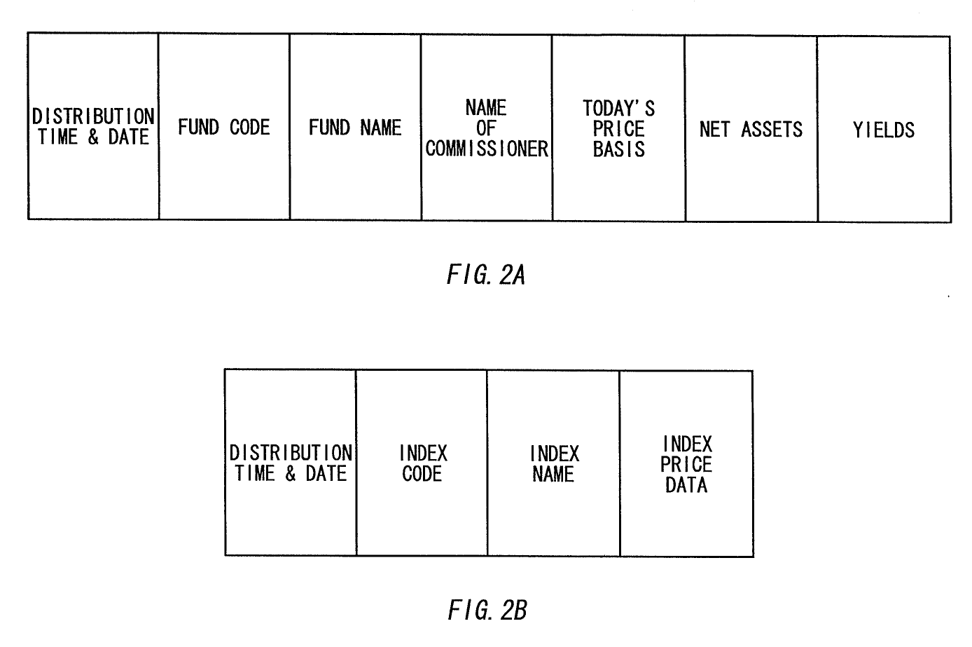

FIG. 2 illustrates data structures to be transmitted to the information display apparatus 30 from the host computer 10 according to a first embodiment of the present invention. FIG. 2A shows a data structure of financial information on investment trusts (financial data of investment trusts). FIG. 2B shows a data structure of financial information on stock price indexes (financial data of indexes). The financial data of investment trusts has fields of, as shown in FIG. 2A: a distribution time and date, which is the time and date for distributing data; a fund code, which is a code number of an investment trust; a fund name, which is the name of an investment trust; the name of commissioner, which is the name of a company that commissions an investment trust; today's price basis; net assets of an investment trust; and yields of an investment trust. The financial data of indexes has fields of, as shown in FIG. 2B: a distribution time and date for distributing data; an index code, which is a code of a stock price index; an index name, which is the name of a stock price index; and an index price data, which is an index value of a stock price index.

The network 20 is constituted by a communication line for communicating information between the host computer 10 and the information display apparatus 30. The network 20 may be a leased line or a commercial line, and may be a fixed-line or a wireless line, for example. The information display apparatus 30 includes a receiver 32, a reservoir 34, an input unit 36 as an example of a specifying-information-accepting unit, a selector 38 as an example of an information selector, a combined value processing unit 40, a display processing unit 42, and a display unit 44. The reservoir 34 accumulates financial information.

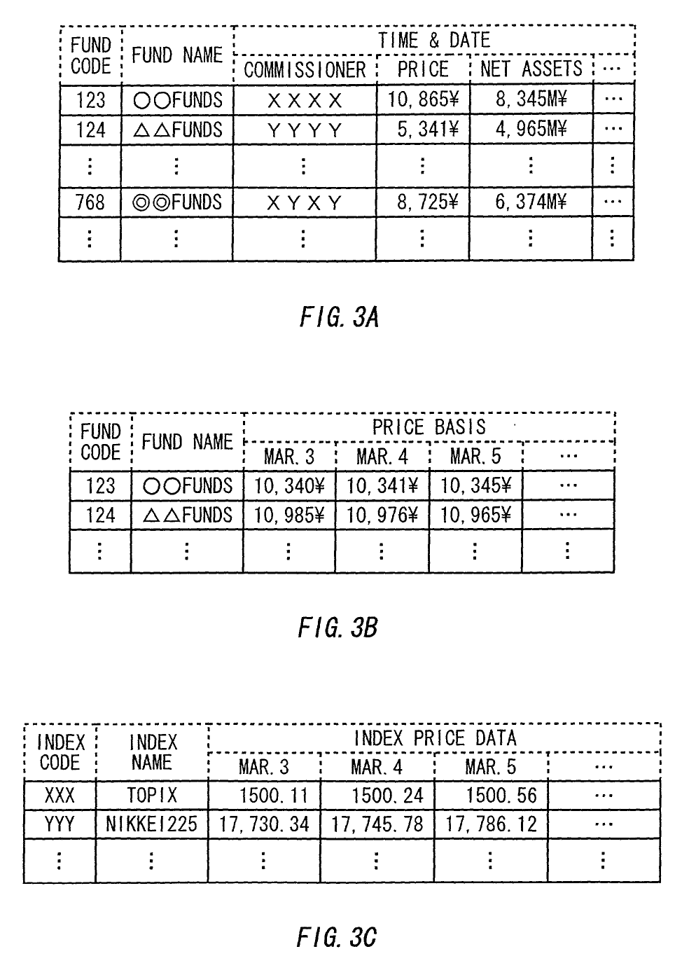

FIGS. 3A, B, and C are structural diagrams showing data accumulated in a reservoir 34 according to the first embodiment of the present invention. FIG. 3A shows detailed data of investment trusts accumulated in the reservoir 34. FIG. 3B shows temporal transitional data of price bases of investment trusts accumulated in the reservoir 34. FIG. 3C shows temporal transitional data of stock price indexes accumulated in the reservoir 34.

Each record of the detailed data of investment trusts has, as shown in FIG. 3A, a fund code, a fund name, a commissioner name, a price basis, and net assets. Each record of the temporal transitional data of price bases of investment trusts has, as shown in FIG. 3B, a fund code, a fund name, and a price basis at a plurality of time points. Each record of the temporal transitional data of stock price indexes has, as shown in FIG. 3C, an index code, an index name, and an index price data at a plurality of time points.

The receiver 32 receives financial information from the host computer 10 through the network 20 and accumulates the received financial information in the reservoir 34. According to the present embodiment, when the receiver 32 receives financial data of investment trusts shown in FIG. 2A, the receiver 32 transfers the fund name, the commissioner name, today's price basis, and the net assets of the financial data of investment trusts to the fund code, the fund name, the commissioner name, the price basis, and the net assets in the record of the detailed data of investment trusts shown in FIG. 3A. Moreover, the receiver 32 transfers today's price bases received from the financial data of investment trusts to the fields of the price basis of the corresponding distribution time and date, which is in the records of the temporal transitional data shown in FIG. 3B that corresponds to the fund code received from the financial data of investment trusts.

Further, when the receiver 32 receives financial data of index prices shown in FIG. 2B, the receiver 32 transfers today's price bases received from the financial data of index prices to the field of the index price data of the corresponding distribution time and date, which is in the record of the temporal transitional data of index prices shown in FIG. 3C that corresponds to the index code received from the financial data of index prices.

The input unit 36 includes a keyboard device, for example, and accepts the inputs from users. According to the present embodiment, the input unit 36 accepts information such as, only for example, a fund code, an index code, a fund name, and an index name, that specifies a single or a plurality of funds or indexes to display temporal transitional graphs. The input unit 36 also accepts information that specifies a plurality of funds, which are the targets of the combined temporal transitional graphs described later. Moreover, the input unit 36 accepts information that specifies a fund for displaying a table relating to the fund. The display unit 44 includes a display apparatus, for example, and displays various information.

When the input unit 36 accepts information that specifies a single or a plurality of funds or indexes to display a temporal transitional graph, the selector 38 selects the corresponding record of a fund or an index from the temporal transitional data of a price basis or an index price stored in the reservoir 34. The selector 38 then outputs the selected record to the display processing unit 42. Further, when the input unit 36 accepts information that specifies a plurality of funds to be targeted as the combined temporal transitional graph described later, the selector 38 selects a plurality of records of the corresponding funds from the temporal transitional data of the price basis stored in the reservoir 34. The selector 38 then outputs the selected records to the display processing unit 42 and the combined value processing unit 40.

Furthermore, when the input unit 36 accepts information that specifies a fund for displaying a table relating to the fund, the selector 38 selects the corresponding records from the detailed data of investment trusts stored in the reservoir 34. The selector 38 then outputs the selected records to the display processing unit 42.

The combined value processing unit 40 calculates a combined value by making a predetermined calculation for a plurality of price bases at the same time point regarding a plurality of time points in a plurality of records relating to a plurality of funds. The combined value processing unit 40 then outputs the combined value of a plurality of time points and the corresponding time point to the display processing unit 42. The calculation may be made by adding each price basis or by adding values that have multiplied a predetermined value by each of the price bases. Moreover, the input unit 36 may accept a designation of the calculation from the user.

When the display processing unit 42 accepts from the selector 38 the record of the fund for displaying a table relating to the fund, the display processing unit 42 instructs the display unit 44 to display a table relating to the fund based on the contents of the record.

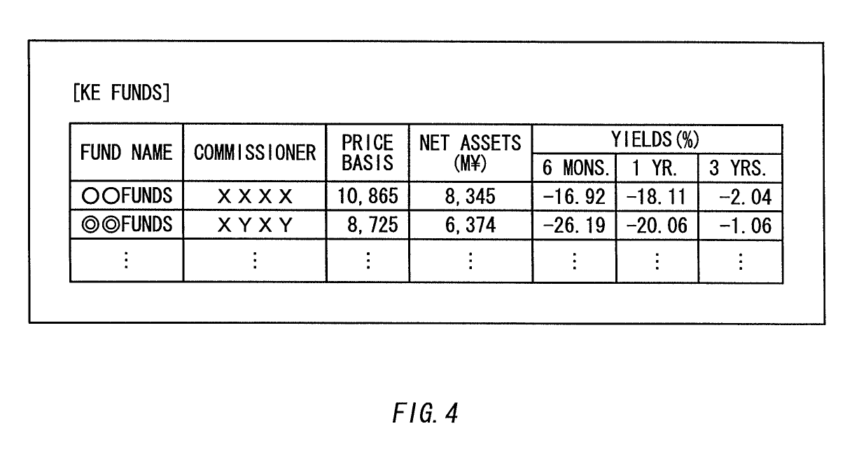

FIG. 4 is an exemplary graph display of a table including information relating to investment trust issues according to the first embodiment of the present invention. As shown in FIG. 4, when fund codes 123 and 768 as in FIG. 3A are input by the input unit 36, the display unit 44 displays information relating to the fund of the fund code 123 and 768, such as the name of a commissioner, a price basis, net assets, and yields, for example. Therefore, when there is an information display apparatus at a sales store of investment trusts, the information display apparatus is able to display information of only investment trusts that the sales store of investment trusts sells, for example. Thus, users may appropriately grasp the kinds of funds that can be purchased at the sales store of investment trusts.

When the display processing unit 42 receives a record of a plurality of funds or indexes from the selector 38, the display processing unit 42 also generates graph data for displaying a temporal transitional graph that shows the relationship between the time point and the price basis or the index price data for each record of each fund or each index. The display processing unit 42 then instructs the display unit 44 to simultaneously display the overlapped temporal transitional graph of a plurality of funds or indexes based on a plurality of graph data.

Further, when the display processing unit 42 receives a combined value at a plurality of time points or the current time point from the combined value processing unit 40, the display processing unit 42 generates graph data for displaying a combined temporal transitional graph that shows the relationship between the current time point and the total value. The display processing unit 42 then instructs the display unit 44 to simultaneously display by overlapping the temporal transitional graph of each fund with the combined temporal transitional graph, based on the generated graph data and a graph data for displaying a temporal transitional graph of a plurality of funds or indexes.

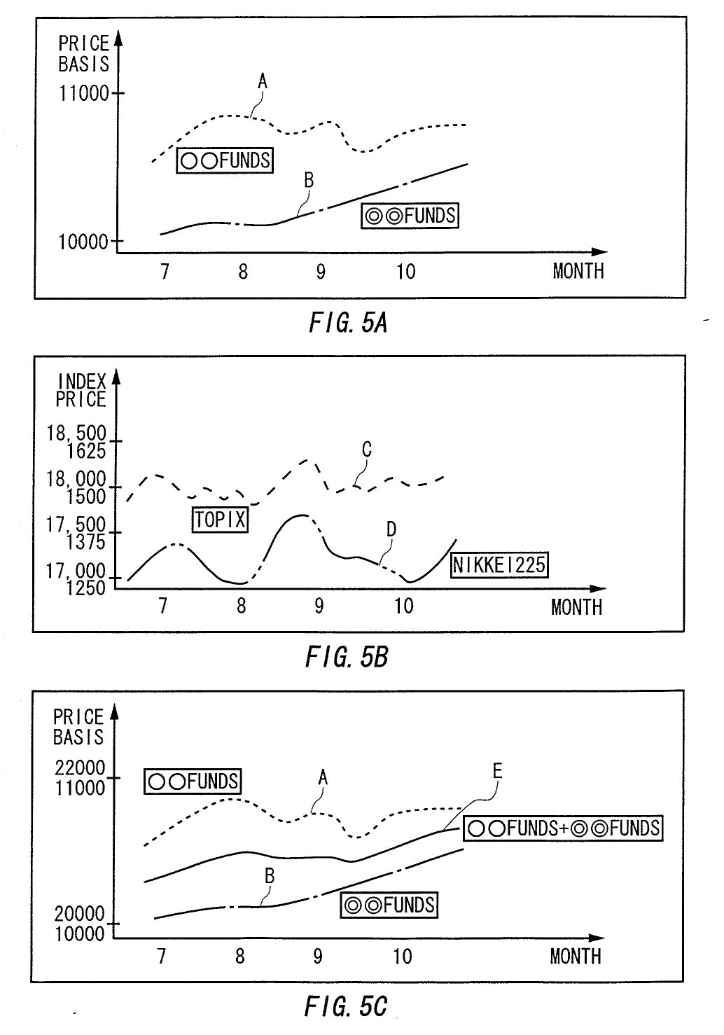

FIGS. 5A, B, and C are exemplary graph displays relating to financial information according to the first embodiment of the present invention. FIG. 5A is an example of a display when fund codes 123 and 768 as in FIG. 3A are input by the input unit 36. FIG. 5B is an example of a display when index codes XXX and YYY as in FIG. 3C are input by the input unit 36. FIG. 5C is an example of a display when fund codes 123 and 768 as in FIG. 3A that are the target of a combined temporal transitional graph are input by the input unit 36.

As shown in FIG. 5A, when the fund codes 123 and 768 as in FIG. 3A are input by the input unit 36, a temporal transitional graph A of the fund corresponding to the fund code 123 and a temporal transitional graph B of the fund corresponding to the fund code 768 are overlapped and displayed. Thus, users can easily compare the temporal transitions of price bases of a plurality of funds by seeing these displays.

As shown in FIG. 5B, when the index codes XXX and YYY as in FIG. 3C are input by the input unit 36, a temporal transitional graph C of the TOPIX corresponding to the index code XXX and a temporal transitional graph D of the Nikkei 225 corresponding to the index code YYY are overlapped and displayed. Thus, users can easily compare the temporal transitions of index prices of a plurality of indexes by seeing these displays.

As shown in FIG. 5C, when the fund codes 123 and 768 as in FIG. 3A are input by the input unit 36, temporal transitional graphs A and-B of the corresponding fund and a combined temporal transitional graph E, which is combined based on the price bases of these funds, are overlapped and displayed. Thus, users can easily grasp the temporal transitions of these values when they purchase a plurality of funds combined.

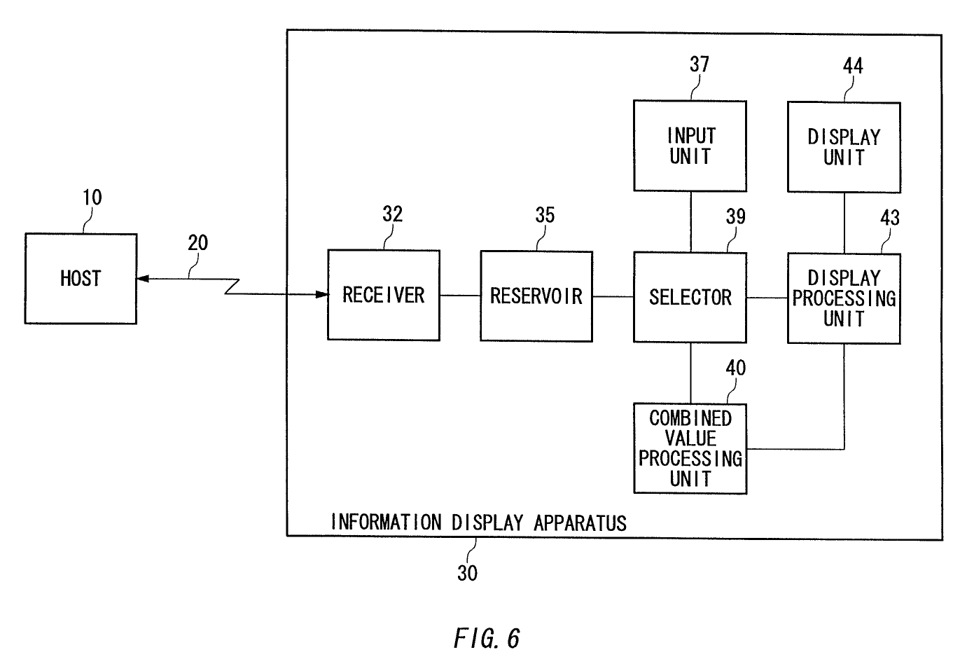

FIG. 6 is a structural diagram of an information display apparatus according to a second embodiment of the present invention. An information display apparatus according to the second embodiment includes a reservoir 35, an input unit 37, a selector 39, and a display processing unit 43. Those components are similar to the reservoir 34, the input unit 36, the selector 38, and the display processing unit 42 of the information display apparatus according to the first embodiment shown in FIG. 1, however, the functional =features are modified therefrom. The descriptions of the reservoir 35, the input unit 37, the selector 39, and the display processing unit 43 are made here regarding the different functions than that of the reservoir 34, the input unit 36, the selector 38, and the display processing unit 42.

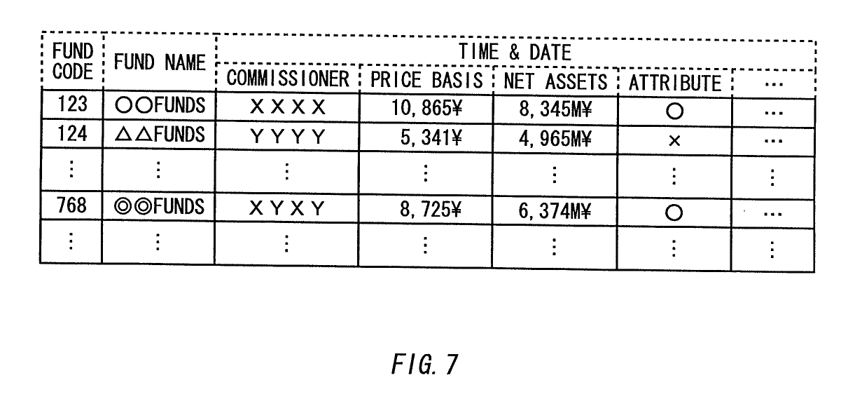

FIG. 7 is a structural diagram showing data accumulated in the reservoir 35 according to the second embodiment of the present invention. The reservoir 35 further includes, as shown in FIG. 7, an attribute relating to display patterns when displaying as a table, in each record of the detailed information data of investment trusts stored in the reservoir 34 shown in FIG. 3A. As an attribute, settings such as an emphasis of characters, an inversion, colors, a blinking, and shading may be fixed, for example.

The input unit 37 further accepts information that specifies a fund to modify the display pattern in a table. When information that specifies a fund to modify the display pattern is input by the input unit 37, the selector 39 selects the record corresponding to the fund of the detailed data of investment trusts in the reservoir 35. The selector 39 then modifies the attribute in the record to a predetermined setting (for example, a shading display). When the display processing unit 43 displays a table relating to a fund, the display processing unit 43 takes out a plurality of records of the detailed information data of investment trusts from the reservoir 35 and displays the table of information relating to the fund stored in each record. The display processing unit 43 displays information about each record with the display pattern based on the attribute of the record.

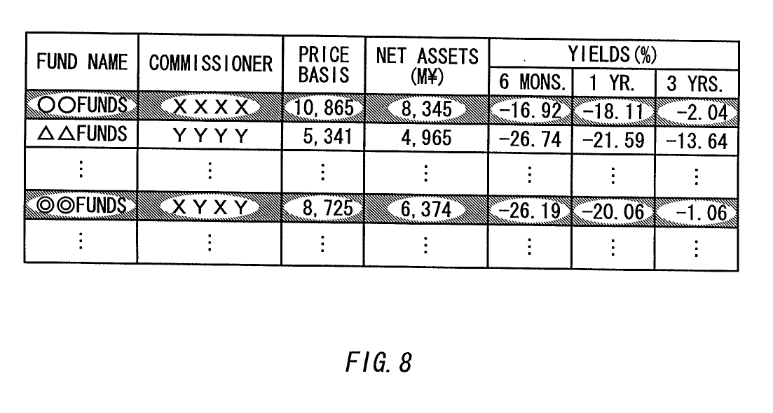

FIG. 8 is an exemplary diagram of a table relating to financial information according to the second embodiment of the present invention. As shown in FIG. 8, when the fund codes 123 and 768 are input by the input unit 37, the display part of the information corresponding to the fund codes 123 and 768 in the table is displayed with the display pattern that is different than the display parts of information of other funds. Therefore, when there is the information display apparatus at a sales store of investment trusts, the display patterns of investment trusts sold at the sales store of the investment trusts can be modified, for example. Thus, users can appropriately grasp the kinds of funds that can be purchased at the sales store.

The scope of the present invention is not limited by the embodiments described above, and various modifications may be possible. For example, although the temporal transitional graph of two funds or indexes are simultaneously displayed according to the first embodiment described above, the present invention does not limit the number of funds or indexes and may simultaneously display a temporal transitional graph of more than three funds or indexes. Moreover, although a combined temporal transitional graph of two funds is displayed according to the embodiments described above, the present invention does not limit the number of funds and may simultaneously display a temporal transitional graph of a combined value of more than three funds.

As is obvious from the description above, the present invention may appropriately provide users information relating to financial information. The present invention may also appropriately provide various pieces of information that are useful for future investments by using the past financial information.

Although the present invention has been described by way of exemplary embodiments, it should be understood that those skilled in the art might make many changes and substitutions without departing from the spirit and the scope of the present invention which is defined only by the appended claims.

What is claimed is:

1. An information display apparatus comprising:
a receiver connecting to a network and receiving financial information through said network;
a reservoir connecting to an output side of said receiver and accumulating said financial information received from said receiver;
a specifying-information-accepting unit for accepting specifying information that specifies said financial information accumulated in said reservoir to be a basis of predetermined information to be displayed;
an information selector connecting to said specifying-information-accepting unit and said reservoir and selecting financial information specified by said predetermined information accepted by said specifying-information-accepting unit from said financial information accumulated in said reservoir; and
a display processing unit connecting to an output of said information selector and displaying said predetermined information based on said financial information selected by said information selector.

2. The information display apparatus as claimed in claim 1, wherein a display pattern of said predetermined information is modified by said display processing unit based on said financial information selected by said information selector with a display pattern of information based on other financial information.

3. The information display apparatus as claimed in claim 1, wherein:
said receiver sequentially receives information about a value of a plurality of fluctuating objects in a financial market through said network;
said reservoir accumulates said information about a value of said fluctuating objects received by said receiver; and
said display processing unit generates a graph relating to each fluctuation of said plurality of fluctuating objects based on said information about a value accumulated in said reservoir and simultaneously displays said generated graph.

4. The information display apparatus as claimed in claim 1, further comprising a combined value processing unit connecting between said selector and said display processing unit and calculating combined value information of a plurality of time points, said combined value information is made by a predetermined calculation about said information about a value of the same time point of a plurality of said fluctuating objects based on said information about a value accumulated in said reservoir, wherein said display processing apparatus displays a graph showing a relationship between said combined value information and said time point based on said combined value information of a plurality of time points calculated by said combined value processing unit.

5. A method of displaying information comprising:
receiving financial information through a network;
accumulating said financial information received by said receiver;
accepting specifying information that specifies said financial information accumulated in said reservoir to be a basis of predetermined information to be displayed;
selecting financial information specified by said predetermined information accepted by said specifying-information-accepting unit from said financial information accumulated in said reservoir; and
displaying said predetermined information based on said financial information selected by said information selector.

6. The information displaying method as claimed in claim 5, wherein a display pattern of said predetermined information is modified based on said financial information selected by said information selector with a display pattern of information based on other financial information.

7. The information display method as claimed in claim 5, wherein:
said receiving sequentially receives information about a value of a plurality of fluctuating objects in a financial market through said network;
said accumulating accumulates said information about a value of said fluctuating objects received by said receiver; and
said displaying generates a graph relating to each fluctuation of said plurality of fluctuating objects based on said information about a value accumulated in said reservoir and simultaneously displays said generated graph.

8. The information display method as claimed in claim 5, further comprising calculating combined value information of a plurality of time points, said combined value information is made by a predetermined calculation about said information about a value of the same time point of a plurality of said fluctuating objects based on said information about a value accumulated in said reservoir, wherein said displaying displays a graph showing a relationship between said combined value information and said time point based on said combined value information of a plurality of time points calculated by said combined value processing unit.

9. A program for displaying information, comprising:
a receiving module for receiving financial information through a network;
an accumulating module for accumulating said financial information received by said receiver;
an accepting module for accepting specifying information that specifies said financial information accumulated in said reservoir to be a basis of predetermined information to be displayed;
a selecting module for selecting financial information specified by said predetermined information accepted by said specifying-information-accepting unit from said financial information accumulated in said reservoir; and
a displaying module for displaying said predetermined information based on said financial information selected by said information selector.

10. The program as claimed in claim 9, wherein a display pattern of said predetermined information is modified based on said financial information selected by said information selector with a display pattern of information based on other financial information.

11. The program as claimed in claim 9, wherein:
said receiving module sequentially receives information about a value of a plurality of fluctuating objects in a financial market through said network;
said accumulating module accumulates said information about a value of said fluctuating objects received by said receiver; and
said displaying module generates a graph relating to each fluctuation of said plurality of fluctuating objects based on said information about a value accumulated in said reservoir and simultaneously displays said generated graph.

12. The program as claimed in claim 9, further comprising a calculating module for calculating combined value information of a plurality of time points, said combined value information is made by a predetermined calculation about said information about a value of the same time point of a plurality of said fluctuating objects based on said information about a value accumulated in said reservoir, wherein said displaying module displays a graph showing a relationship between said combined value information and said time point based on said combined value information of a plurality of time points calculated by said combined value processing unit.

13. An information display system comprising:
a host computer generating financial information;
a network connecting to said host computer and transmitting said financial information;
a receiver connecting to said network and receiving said financial information;
a reservoir connecting to an output of said receiver and accumulating said financial information received by said receiver;
a specifying-information-accepting unit for accepting specifying information that specifies said financial information accumulated in said reservoir to be a basis of predetermined information to be displayed; and
an information selector connecting to said specifying-information-accepting unit and said reservoir and selecting financial information specified by said predetermined information accepted by said specifying-information-accepting unit from said financial information accumulated in said reservoir.

14. The information displaying system comprising:
a receiver connecting to a network and sequentially receiving information about a value of a plurality of fluctuating objects in a financial market through said network;
a reservoir connecting to an output of said receiver and accumulating said information about a value of said fluctuating objects received by said receiver;
a combined value processing unit connecting to said reservoir and calculating combined value information of a plurality of time points, said combined value information is made by a predetermined calculation about information about a value of the same time point of a plurality of fluctuating objects based on said information about a value accumulated in said reservoir; and
a display processing unit connecting to said combined value processing unit and generating a graph relating to each fluctuation of said plurality of fluctuating objects based on said information about a value accumulated in said reservoir, simultaneously displaying said generated graph, and displaying a graph showing a relationship between said combined value information and said time point based on said combined value information of a plurality of time points calculated by said combined value processing unit.
